(19) United States
(12) Patent Application Publication
(10) Pub. No.: US 2018/0283085 A1
(43) Pub. Date: Oct. 4, 2018

(54) RAIN SHIELD FOR SINGLE AND DOUBLE HUNG WINDOWS

(71) Applicant: Bobby R. Soha, Brooklyn, OH (US)

(72) Inventor: Bobby R. Soha, Brooklyn, OH (US)

(21) Appl. No.: 16/000,040

(22) Filed: Jun. 5, 2018

Related U.S. Application Data
(63) Continuation-in-part of application No. 14/641,165, filed on Mar. 6, 2015.

(51) Int. Cl. E06B 3/28

(52) U.S. Cl. CPC E06B 3/28; E06B 2009/005

(57) ABSTRACT

A rain shield is provided for exterior architectural windows which prevents rain water from intruding into a dwelling. The rain shield may include a generally rectangular-planar shield member. The device may also include first and second lower fixed pivots disposed on a lower portion of opposing sides of the shield member. The first and second fixed pivots may be oppositely directed from each other and cooperate to pivot the device between stowed and deployed configurations. The rain shield may also include first and second lateral supports disposed on either side of the shield member.

### I. BACKGROUND OF THE INVENTION

### A. Field of Invention

Embodiments may generally relate to the field of rain shields for residential windows.

### B. Description of the Related Art

A long-standing problem with exterior single and double hung architectural windows is that they permit water intrusion if they are kept open during a rain storm. Window screen is common, but ineffective. Screen partially excludes rain droplets but permits a significant amount of spray to pass through the screen. Another common solution is an exterior awning mounting to the dwelling. While effective, they are not aesthetically pleasing to many homeowners. To those who do not appreciate the look of a traditional awning, there remains no other solution that to either close the window or accept water intrusion as a necessary side-effect. Thus, there remains a gap in the art where homeowners have no device that they can use from inside the home to exclude rain water while keeping their windows open during a rain storm.

Some embodiments of the present invention may provide one or more benefits or advantages over the prior art.

### II. SUMMARY OF THE INVENTION

Some embodiments may relate to a rain shield for an exterior architectural window, comprising: a shield member defining a generally rectangular-planar surface. The shield member may include a top edge, a bottom edge, a first side edge, and a second side edge. A first side panel member of the device may define a generally triangular-planar surface. The first side panel member may include an outward face and an inward face, and having three side edges, namely, a top side edge, a hinge side edge, and a clasp side edge. The hinge side edge may be hingedly joined to the first side edge of the shield member. The device may further include a first clasp member disposed at the clasp side edge of the first side panel member, and may comprise a portion of the first side panel member turned outwardly at about 90 degrees relative to the outward face of the first side panel member. Embodiments may further include a second side panel member defining a generally triangular-planar surface. The second side panel member may include an outward face and an inward face, and may have three side edges, namely, a top side edge, a hinge side edge, and a clasp side edge. The hinge side edge is hingedly joined to the first side edge of the shield member. The device may further include a second clasp member disposed at the clasp side edge of the second side panel member. The clasp may comprise a portion of the second side panel member turned outwardly at about 90 degrees relative to the outward face of the second side panel member.

According to some embodiments a shield member defines a width between the first and second side edges approximately equal to the width of a co-operable architectural window opening.

According to some embodiments a the shield member comprises: an inner shield panel defining a generally rectangular-planar surface having a top edge, a bottom edge, a first side edge, and a second side edge; and an outer shield panel defining a generally rectangular-planar surface having a top edge, a bottom edge, a first side edge, and a second side edge, wherein the outer shield panel further comprises a top channel disposed at the top edge of the outer shield panel, and a bottom channel disposed at the bottom edge of the outer shield panel, and wherein the top channel slideably receives the top edge of the inner shield panel, and the bottom channel slideably receives the bottom edge of the inner shield panel.

According to some embodiments a the first side panel member is hingedly joined to the first side edge of the outer shield panel, and the second side panel member is hingedly joined to the second side edge of the inner shield panel.

According to some embodiments a the hinge side edges of the first and second side panel members are hingedly joined to the shield member through first and second flex hinge panels.

Embodiments may also comprise a bottom channel defined by a flap of the outer shield panel extending from the bottom edge of the outer shield panel parallel to and spaced apart from the outer shield panel.

Embodiments may also comprise a top channel defined by a flap of the outer shield panel extending from the top edge of the outer shield panel parallel to and spaced apart from the outer shield panel.

Embodiment may relate to a rain shield for an exterior architectural window. Such a device may include a shield member defining a generally rectangular-planar surface having a top edge, a bottom edge, a first side edge, and a second side edge. The device may also have a first lower fixed pivot disposed on a lower portion of the first side of the shield member. It may further include a second lower fixed pivot disposed on a lower portion of the second side of the shield member. Moreover, the first and second fixed pivots are oppositely directed from each other. The rain shield may also include a first retractable upper lateral support disposed on an upper portion of the first side of the shield member; and a second retractable upper lateral support disposed on an upper portion of the second side of the shield member.

According to some embodiments the shield member comprises an upper shield member and a lower shield member subtending an interior angle φ between 100° and 170°.

According to some embodiments the first upper lateral support comprises a first folding brace having a first slide pin outward-laterally disposed on an outward-facing surface of the first folding brace.

According to some embodiments the second upper lateral support comprises a second folding brace having a second slide pin outward-laterally disposed on an outward-facing surface of the second folding brace, wherein the first and second slide pins are co-operable with laterally disposed vertical tracks of a window frame to support the rain shield in tension with the vertical tracks.

According to some embodiments the first lower fixed pivot, the second lower fixed pivot, the first upper lateral support, and/or the second upper lateral support are adapted to retain the rain shield in a stowed and/or deployed configuration.

According to some embodiments the first and/or second lower fixed pivots comprise either a pivot pin or a recess operable to receive a pivot pin, the pivot pin and recess being co-operably matable as a journal bearing.

Embodiments may further comprise a window frame. According to such embodiments the first upper lateral support may comprise a first folding brace having a first slide pin outward-laterally disposed on an outward-facing surface of the first folding brace. A second upper lateral support may comprise a second folding brace having a second slide pin outward-laterally disposed on an outward-facing surface of the second folding brace. A first laterally disposed vertical track of the window frame may be co-operable with the first slide pin to support the rain shield in tension. The first slide pin may be slidably received by the first vertical track. A second laterally disposed vertical track of the window frame may be co-operable with the second slide pin to support the rain shield in tension. The second slide pin may be slidably received by the second vertical track. The window frame may be dimensioned to receive the shield member, the first and second lower fixed pivots, and the first and second upper lateral supports in a fully stowed configuration without interfering with the window frame or with an upper or lower window pane.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1 is a side perspective view of an embodiment installed in a prefabricated double hung window;

FIG. 2 is an opposing side perspective view of the embodiment of FIG. 1;

FIG. 3 is a top perspective view of the embodiment of FIG. 1 showing a clasp cooperating with a window track;

FIG. 4 is a plan view from the exterior side of an embodiment;

FIG. 5 is a perspective view of the embodiment of FIG. 4 from the exterior side;

FIG. 6 is a plan view from the exterior side of an embodiment;

FIG. 7 is a perspective view of the embodiment of FIG. 6 from the exterior side;

FIG. 8 is a cross sectional view of the embodiment of FIG. 7 taken along line 8-8;

FIG. 9 is an elevation view of an embodiment;

FIG. 10A is a side-view of the embodiment of FIG. 9 viewed from the direction indicated by line 10b-10b showing the embodiment in a fully deployed configuration;

FIG. 10B is a side-view of the embodiment of FIG. 9 viewed from the direction indicated by line 10b-10b showing the embodiment in a configuration between deployed and stowed; and

FIG. 10C is a side-view of the embodiment of FIG. 9 viewed from the direction indicated by line 10b-10b showing the embodiment in a fully stowed configuration.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree such as “about” or “approximately” are used herein to describe non-exact quantities. Read in context, the person having ordinary skill in the art would understand how to make and use the invention within the constraints of these terms, and without undue experimentation.

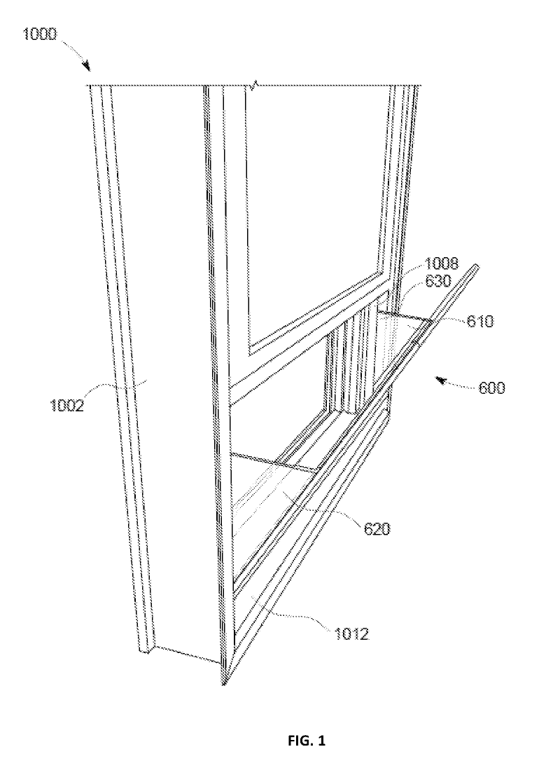

Referring now to the drawings wherein the showings are for purposes of illustrating embodiments of the invention only and not for purposes of limiting the same, FIG. 1 is a perspective view of a two-panel expandable-width embodiment installed in a prefabricated architectural window 1000. The device is shown installed inside a widow frame 1002 resting against a bottom lip 1012 of the window 1000. The embodiment includes a shield member 600, a first side panel 610 and a second side panel 620. Further, the embodiment is shown anchored to a track 1008 of the window ordinarily used to slide the window pane up and down. The embodiment engages the track 1008 with a clasp member 630. The shield member 600 is angled away from the window frame 1002 by the triangular side members 610, 620 which are both clasped to the window track 1008. This creates a space where outside air can flow into the dwelling while the shield member 600 catches any rain water and returns it to the window frame 1002 where it can flow to the outside.

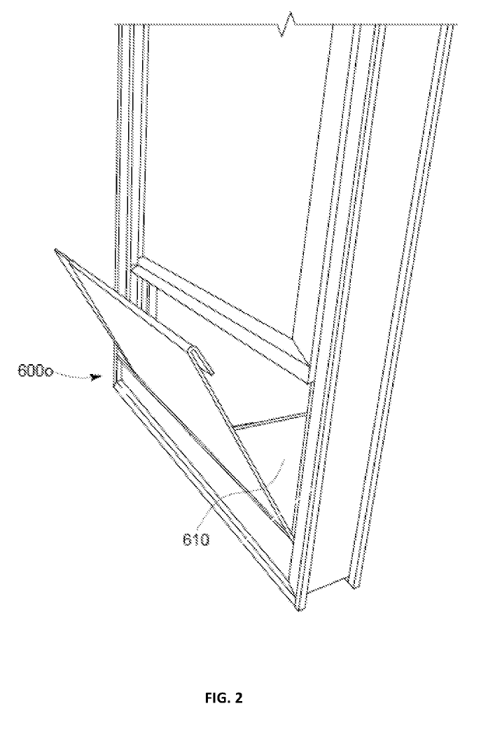

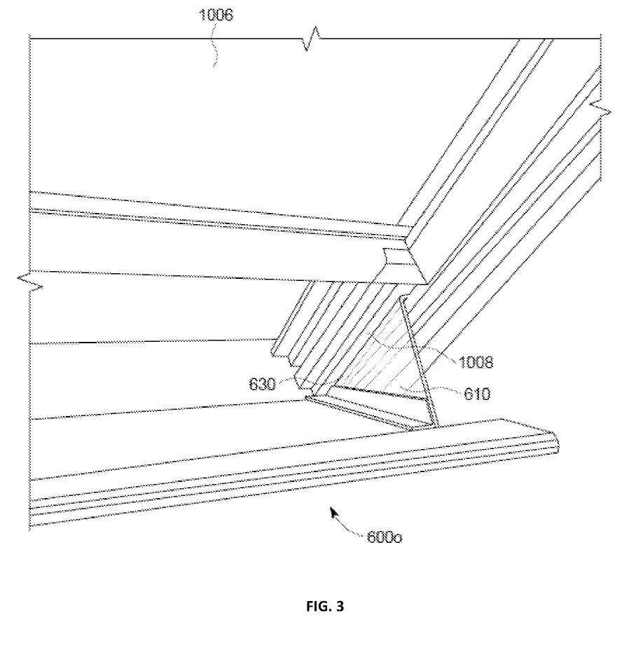

FIG. 2 shows the same embodiment of FIG. 1 from the opposing side where the outer shield panel 600o is clearly visible. Comparing FIG. 1 and FIG. 2 makes it clear that the first and second side members 610, 620 of this embodiment are mirror images of each other. FIG. 3 is a top perspective view showing the clasp 630 of the first side panel 610 cooperating with the window track 1008.

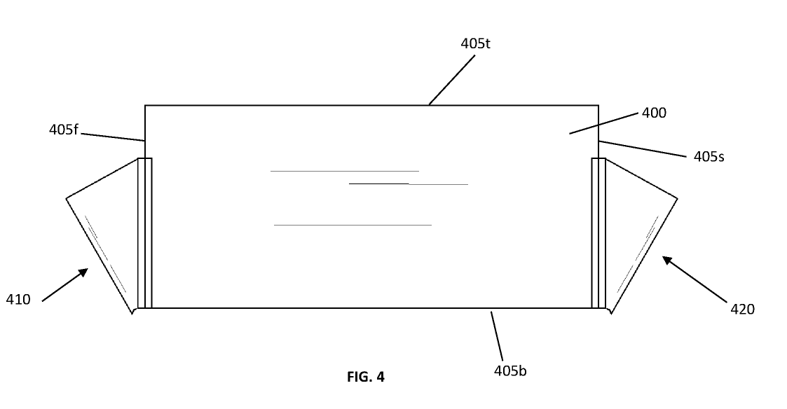

FIG. 4 is a plan view of a single-panel embodiment. The embodiment is viewed from the window-facing side. It includes a shield panel 400 having a top edge 405t, a bottom edge 405b, a first side edge 405f, and a second side edge 405s collectively defining a generally rectangular-planar shaped surface. The embodiment also includes a first side panel member 410, and a second side panel member 420 both of which include clasps as will be describe in more detail.

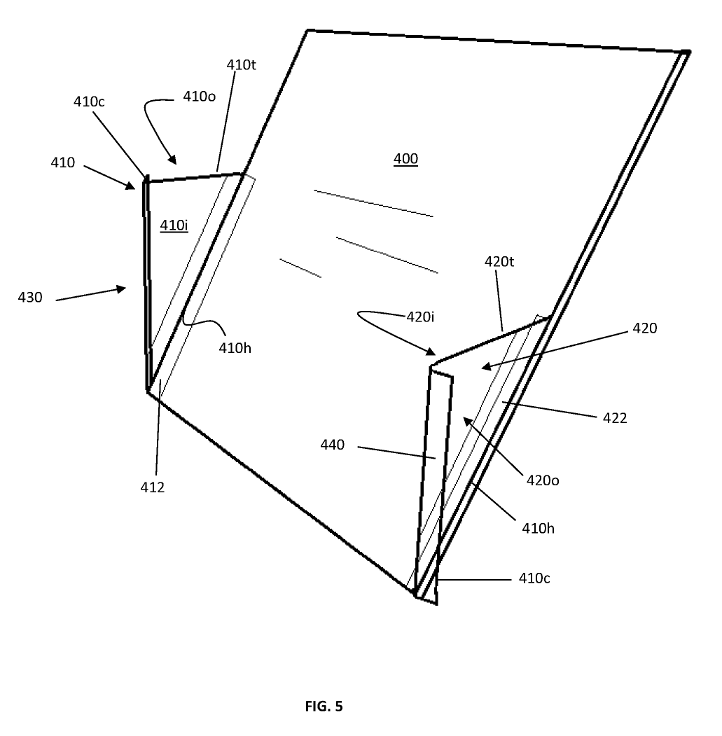

FIG. 5 is a perspective view of the FIG. 4 embodiment viewed from the window-facing side. This view better illustrates the motion of the side panel members about their hinges 412, 422. More specifically, the first side panel member 410 includes a top edge 410t, a hinge edge 410h, and a clasp edge 410c, defining a generally triangular sheet. Being a generally triangular sheet, the first side panel member further includes an inward face 410i, and an outward face 410o. The first side panel member 410 further includes a first clasp member 430. The first clasp member 430 of the illustrated embodiment is simply an extension of the sheet material forming the first side panel member 410 folded outward at about 90 degrees relative to outward face 410o. Accordingly, the clasp edge 410c of the first side panel member is the terminal edge of the portion of the sheet forming the clasp 430.

As used here, the terms inward and outward are used relative to the embodiment, and not with reference to the interior or exterior of a dwelling. More specifically, “inward” and “outward” refer to the partially enclosed space formed by the embodiment when installed in a window. Thus, an “inward” surface faces toward the partially enclosed space, while an “outward” surface faces away from the partially enclosed space.

With further regard to FIG. 5, the first side panel member 410 is hingedly joined to the to the first side edge 405f of the shield member, i.e. panel 400. In the present embodiment the parts are hingedly joined through a flexible polymer hinge panel 412 bonded to both parts along the hinge side edge 410h and the first side edge 405f respectively. The hinge panels 412 and 422 each comprise a strip of flexible polymeric sheet material, which may be bonded, welded, or otherwise joined to the side panel member and side edge of the shield panel.

The skilled artisan will readily appreciate that the invention is not limited to flexible hinge panels, and in fact includes any suitable structure capable of achieving the desired range of motion. For instance, embodiments may utilize a living hinge whereby the side panel members are integrally formed with the shield panel as a single continuous part rather than joined parts. Alternatively, embodiments may be molded as a sufficiently thin and flexible sheet so that no hinge is necessary. For instance, a molded embodiment may have the side panel members fixed in a configuration ready to clasp a window track. In such embodiments, the thin sheet may be sufficiently flexible to be elastically bent by hand thus permitting easy installation in a window track.

Continuing with respect to FIG. 5, the second side panel member 420 is a mirror image of the first 410. Like the first side panel member 410, the second 420 includes a top edge 420t, a hinge edge 420h, and a clasp edge 420c, an inward face 420i, and an outward face 420o. Similarly, the second side panel member 420 includes a second clasp member 440 formed from an extension of the side member's 420 sheet material bent at about 90 degrees relative to the outward face 420o. Moreover, the second side panel member 420 is hingedly joined at its hinge edge 420h to the second side edge 405s of the shield panel 400, by a second flex hinge panel 422 bonded thereto.

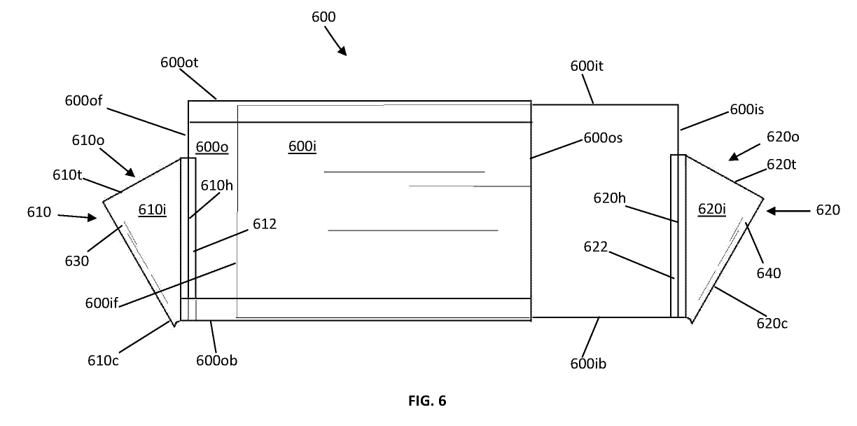

FIG. 6 is a plan view illustration of a width-adjustable embodiment viewed from the window-facing side of the embodiment. In contrast to the embodiment of FIGS. 4 and 5, the width-adjustable embodiment includes a shield member 600 comprising two parts, namely, an inner shield panel 600i, and an outer shield panel 600o which are adapted, as will be described shortly, to slidably cooperate with each other to fit windows having a range of widths. The inner shield panel 600i includes a top edge 600it, a bottom edge 600ib, a first side edge 600if, and a second side edge 600is, which collective define a generally rectangular sheet. Similarly, the outer shield panel 600o includes a top edge 600ot, a bottom edge 600ob, a first edge 600of, and a second edge 600os, which collectively define a generally rectangular sheet. The outer shield panel 600o includes channels or tracks that slidably receive the inner shield panel 600i, thus creating the width-adjusting feature of the embodiment. As will described in more detail, these tracks or channels may be formed, for example and without limitation, by folding over the sheet material defining the outer shield panel 600o.

Similar to the embodiment illustrated in FIGS. 4 and 5, the width-adjustable embodiment includes a pair of mirror image side panel members, denominated first side panel member 610 and second side panel member 620. The side panel members respectively include a top side edge 610t, 620t; a hinge side edge 610h, 620h; and a clasp slide edge 610c, 620c collectively defining generally triangular sheets. Both side members 610, 620 also include inward faces 610i, 620i; and outward faces 610o, 620o. Further, the first side member 610 includes a first clasp member 630 while the second clasp member 620 includes a second clasp member 640. The first side panel member 610 is hingedly joined along its first hinge side edge 610h to the shield member 600 along the first side edge of the outer shield panel 600of through a first flex hinge panel 612. Similarly, the second side panel member 620 is hingedly joined along its second hinge side edge 620h to the shield member 600 along the second side edge of the inner shield panel 600is through a second flex hinge panel 612.

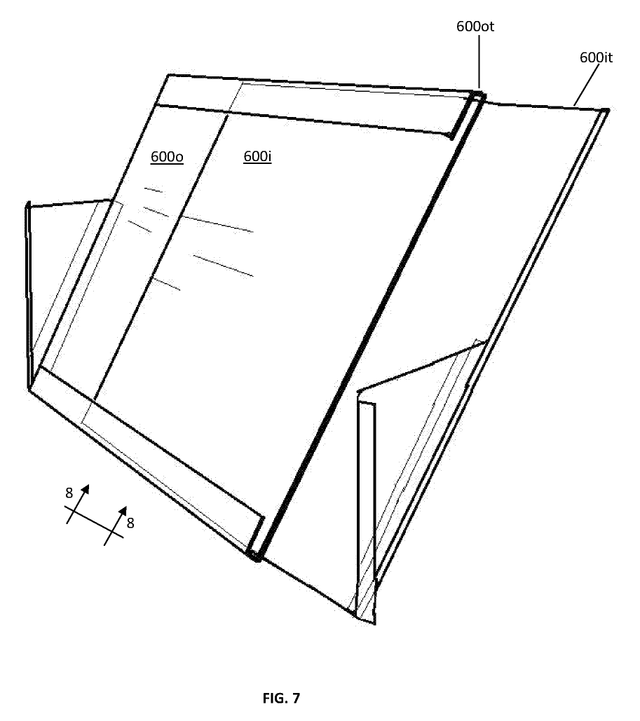

Turning to FIG. 7, the embodiment of FIG. 6 is shown in a window-facing perspective view more clearly illustrating the channel of the outer shield panel 600o. The inner shield panel 600i is shown being slidably received by the outer shield panel 600o in top and bottom channels. The top and bottom channels of the illustrated embodiment are defined by a continuous extension of the sheet material of the outer shield panel 600o folded over so as to leave a gap sized to slidably receive the inner shield panel 600i.

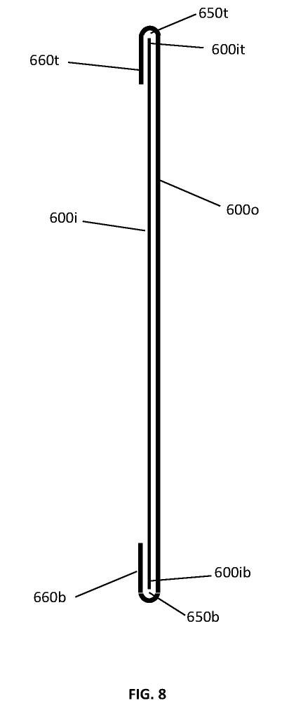

The channels and the sliding relationship between the inner and outer shield panels are further illustrated in FIG. 8, which is a cross sectional view of the embodiment illustrated in FIG. 7 taken along line 8-8. Specifically, a top channel flap 660t is shown as a continuous extension of the same sheet material forming the outer shield panel 600o. The flap 660t is folded over parallel to the outer shield panel 600o defining a top channel 650t comprising a gap between the flap 660t and the outer shield panel 600o sized to receive the top edge 600it of the inner shield panel 600i in a suitable clearance fit. The skilled artisan will readily appreciate that the fit shown in FIG. 8 is exaggerated for the sake of illustration. The bottom channel 650b of the illustrated embodiment is a mirror image of the top channel 650t, and is similarly formed by folding flap 660b of the outer shield panel 600o over while leaving a suitable gap to receive the bottom edge 600ib of the inner shield panel 600i in a suitable clearance fit.

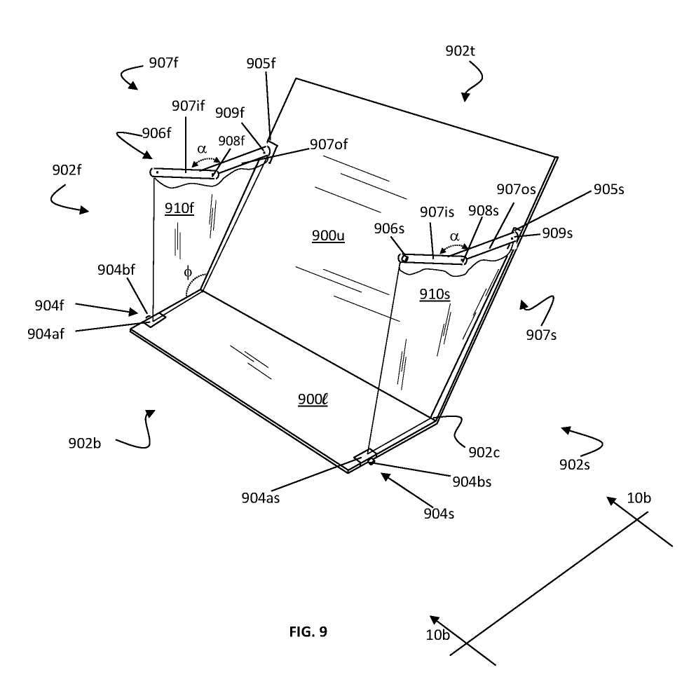

Turning to FIG. 9, an embodiment is illustrated that is designed to be integrated with an architectural window as a built-in component thereof. This built-in embodiment includes an upper shield panel 900u and lower shield panel 900l. The upper and lower panels may be comprised of the same continuous sheet material bent along a shield panel crease 902c at a fixed angle φ. Though referred to as a crease, the skilled artisan will readily appreciate that the shield panel crease 902c need not be a sharp crease, but rather may be a gentle rounded bend as well.

What is important is that the upper and lower panels subtend an angle φ sufficient provide an open space allowing for outside air to flow in through the window. Suitable values of φ include, without limitation, between 100 and 170 degrees. Other suitable ranges include between 100° and 110°, 110° and 120°, 120° and 130°, 130° and 140°, 140° and 150, 150° and 160°, 160° and 170°, and any combination thereof.

With continuing reference to FIG. 9, the embodiment includes a top edge 902t, a bottom edge 902b, a first side 902f, and a second side 902s. According to the illustrated embodiment lower fixed pivots 904f, 904s are created on the first and second sides 902f, 902s of the lower shield panel 900l by mounting a pivot pin. More specifically, a first pivot pin mounting bracket 904af is joined, according to well-known means, to the first side 902f of the lower shield panel 900g. The mounting bracket 904af includes a pivot pin 904bf. Similarly, a second mounting bracket 904as is joined to the second side 902s of the lower shield panel 900l, and similarly includes a pivot pin 904bs. The pivot points 904f, 904s are co-operably received by apertures defined in the inside frame of an architectural window (not shown). The skilled artisan will readily appreciate that the invention is not limited to the illustrated pivot pins, or even to mounted pivot pins. Any of a wide variety of means well-known in the art accomplish the same pivoting function and are thus within the scope of the invention. By way of non-limiting example, pivot pins may be integral and continuous with the lower shield panel 900l, as a single molded part. Alternatively, the male pins may be integral with the cooperating window frame while the lower shield member may instead include female recesses for receiving the pivot pins.

With continuing regard to FIG. 9, the illustrated embodiment includes a retractable upper lateral support in the form of a pair of folding braces 907f, 907s. 906 outer arm 907of, 907os. The inner and outer arms are pivotally joined at first and second bifold points respectively 908f, 908s thus defining an angle α between the inner and outer arms. The angle α varies between about zero degrees when the illustrated embodiment is fully stowed and about 180 degrees when it is fully deployed. In FIG. 9 the inner 907if, 907is and outer 907of, 907os arms are shown in an intermediate configuration where a is between 0° and 180°. The outer arms 907of, 907os of the illustrated embodiment are shown pivotally joined to first and second folding brace mounting brackets 905f, 905s at first and second pivot points 909f, 909s. The mounting brackets 905f, 905s may be joined to either side 902f, 902s of the upper shield panel 900u through any suitable means known in the art. Moreover, the pivot points 908f, 908s, 909f, and 909s may comprise any of a wide variety of well-known structures for achieving such motion, for example and without limitation, common structures include pins, rivets, or similar annular structures suitable for use as journals.

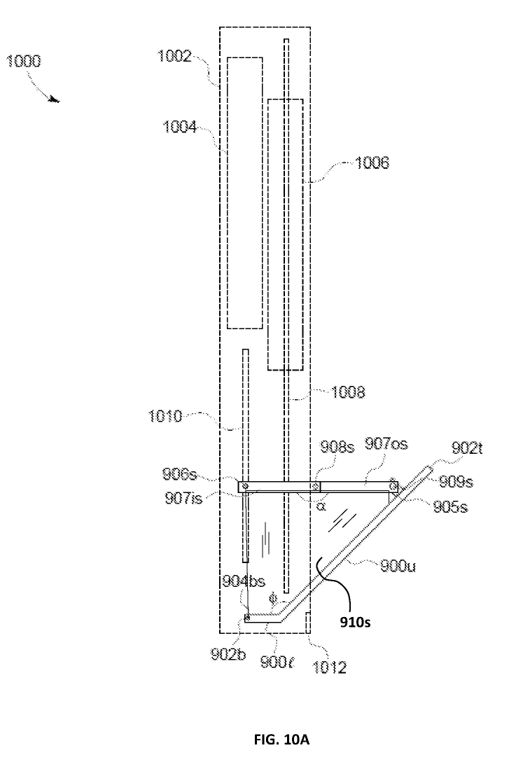

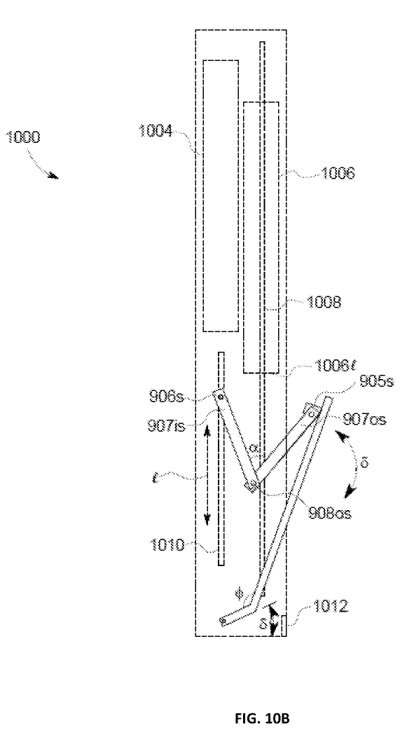

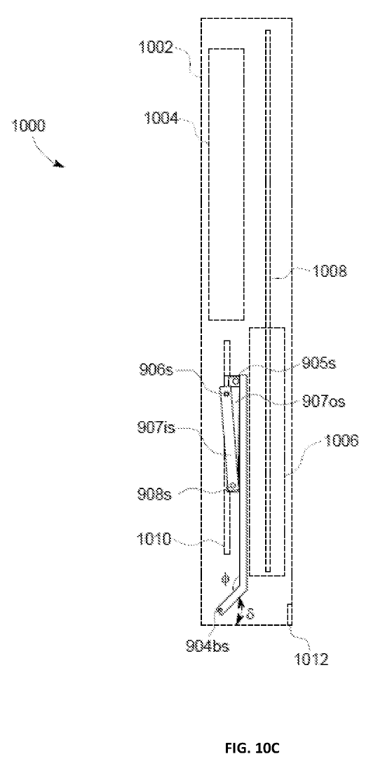

With further reference to FIG. 9, the folding braces 907f, 907s include slide pins 906f (not visible), 906s outward-laterally disposed on outward-facing surfaces of the first and second inner arms 907if, 907is of the first and second folding braces 907f, 907s. The first and second slide pins 906f (not visible), 906s are outward-laterally disposed so as to slidably cooperate with dedicated vertical tracks disposed on the inside of the window frame (not shown) lateral to the embodiment. The upper lateral supports thus support the rain shield in tension with the tracks of the window frame. The operation of the slide pins 906f (not visible), 906s and the embodiment overall is more readily apparent with reference FIGS. 10A, 10B and 10C. These figures show a side view of the built-in embodiment of FIG. 9 from the direction indicated by line 10b-10b.

Finally, with respect to FIG. 9, an embodiment may optionally include first and second folding side-panel baffles 910f, 910s, which serve to prevent rain from entering through the sides of the embodiment. FIG. 9 illustrates the baffles 910f, 910s in an intermediate state between stowed and deployed. Thus, the baffles 910f, 910s are shown partially folded. In contrast, FIG. 10A shows the second baffle 910s in a fully deployed state where the baffle is flat rather than partially folded. The person having ordinary skill in the art will readily understand that the baffles may take on any of a wide variety of forms. For example, and without limitation, a baffle may comprise a flexible polymer sheet fastened to a side of the device so that it folds with the device as the device is stowed and unfolds with the device as it is deployed. The ordinarily skilled artisan will readily understand how to fasten and/or bond the polymer sheet to the device according to well-known means.

Turning now to FIG. 10A, a single-hung window 1000 is shown with the built-in embodiment of FIG. 9 operably installed and in a fully deployed configuration. The window 1000 includes a window frame 1002 receiving a fixed upper window pane 1004 and a slidable lower window pane 1006. The slidable lower window pane 1006 is slidably received by a track 1008 such that window pane 1006 can be raised and lowered to open and close the window 1000. The inner and outer arms 907is, 907os are shown fully extended such that they subtend an angle α of about 180 degrees. The second slide pin 906s is shown slidably engaging integral track 1010, which is built into the window frame 1002. The lower shield panel 900l is shown roughly parallel to the bottom of the window frame 1002, although the relative orientation of the lower shield panel in this respect is a matter of convenience. The second pivot pin 904bs pivotably engages an aperture (not shown) in the window frame 1002. Accordingly, lower end of the embodiment is fixed in place except that it is free to rotate about the second pivot pin 904bs, The upper shield panel 900u may or may not rest against the bottom lip 1012 of the window when the embodiment is fully deployed. The second baffle 910s is also shown in a fully deployed configuration. This structure is not illustrated in FIGS. 10B and 10C, although FIGS. 10B and 10C otherwise illustrate the same structure as FIG. 10A.

Turning to FIG. 10B, the built-in embodiment is illustrated in an intermediate state between fully deployed and fully stowed. While the angle φ remains fixed, the angle α is somewhere between 0° and 180°. The second slide pin 906s has slid upward according to line l along track 1010. The top edge 902t of the upper shield panel 900u has swung an angle δ from its fully deployed position along a path that will allow it to clear the lower edge 1006l of the sliding lower window pane 1006. Finally, as shown in FIG. 10C, and a is zero and sliding pin 906s has reached the top of its range of motion in track 1010. Accordingly, the inner and outer folding brace arms 907is, 907os are fully folded, and the built-in embodiment is fully stowed. Thus, the lower sliding window pane 1006 can be closed.

While the folding braces 907f, 907s have been discussed in detail, the skilled artisan will appreciate that this is only one among a wide range of suitable structures. Any known structure or combination of structures that provide suitable bracing to protect the embodiment from vertical loading while deployed would be a suitable substitute. Advantageously, such structure may also provide for retaining the embodiment in a fully stowed and/or fully deployed position and/or even in intermediate positions such as that of FIG. 10B. For example, the illustrated bifold braces may include one or more simple ball catches to fix the position of a brace.

Such a ball catch is known to be readily made by metal stamping a hemispherical divot into matable parts; the male side of one mating with the female side of the other. Other such retaining structures are well known in the art, and may include, for instance and without limitation, tight-fitting journal bearings having sufficient friction to hold the journal in a particular angular position under the weight of the rain shield itself, i.e. and without added loading, while providing for angular motion of the journal under small applied forces, i.e. easy manual manipulation. The skilled artisan will readily appreciate that such journal bearings may be incorporated into either or both of the lower fixed pivots, either or both of the upper lateral supports, or any combination thereof. Other retaining structures may include window frame-mounted retaining clips adapted to cooperate with the upper or lower shield panel, or any other suitable part of the rain shield, in a snap fit to hold it in a stowed configuration. Again, the foregoing retaining structures are recited merely for the purpose of illustrating the myriad suitable solutions that the skilled artisan may select as a matter of design choice. Accordingly, the skilled artisan would readily appreciate how to adapt embodiments of the invention to retain them in a stowed and/or deployed configuration.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

The following list shows the correlation between the various reference numerals used in the appended drawings, and the elements of the drawings that they represent. This list is provided only for convenience and is not intended to be limiting in any way. Abbreviated, shortened, or otherwise somewhat different wording may be used herein to describe the same structures or drawing elements without obscuring their meaning to the person having ordinary skill in the art.
δ swing angle
α angle between inner and outer arms of the folding brace (0°≤α≤180°)
fixed inside angle between the upper and lower shield panels
l linear motion of slide pin (e.g. 906s)
400 shield panel
405t top edge of shield panel 400
405b bottom edge of shield panel 400
405f first side edge of shield panel 400
405s second side edge of shield panel 400
410 first side panel member
410t top edge of first side panel member
410h hinge side edge of first side panel member
410c clasp side edge of first side panel member
410o outward face of first side panel member
410i inward face of first side panel member
412 first flex hinge panel
420 second side panel member
420t top edge of second side panel member
420h hinge side edge of second side panel member
420c clasp side edge of second side panel member
420o outward face of second side panel member
420i inward face of second side panel member
422 second flex hinge panel
430 first clasp member
440 second clasp member
600 shield member
600i inner shield panel
600it top edge of inner shield panel
600ib bottom edge of inner shield panel
600if first side edge of inner shield panel
600is second side edge of inner shield panel
600o outer shield panel
600ot top edge of outer shield panel
600ob bottom edge of outer shield panel
600of first side edge of outer shield panel
600os second side edge of outer shield panel
610 first side panel
610o first outward face of first side panel
610i first inward face of first side panel
610t first top side edge of first side panel
610h first hinge side edge of first side panel
610c first clasp side edge of first side panel
612 first flex hinge panel
620 second side panel
620o second outward face of second side panel
620i second inward face of second side panel
620t second top side edge of second side panel
620h second hinge side edge of second side panel
620c second clasp side edge of second side panel
622 second flex hinge panel
630 first clasp member
640 second clasp member
650t top channel
650b bottom channel
660t top channel flap
660b bottom channel flap
900u upper shield panel
900l lower shield panel
902t top edge
902b bottom edge
902f first side
902s second side
902c shield panel crease
904f first lower fixed pivot
904af first pivot pin mounting bracket
904bf first pivot pin
904s second lower fixed pivot
904as second pivot pin mounting bracket
904bs second pivot pin
905f first folding brace mounting bracket
905s second folding brace mounting bracket
906f first slide pin (arrow pointing out-of-view)
906s second slide pin
907f first folding brace
907if inner arm of first folding brace
907of outer arm of first folding brace
907s second folding brace
907is inner arm of second folding brace
907os outer arm of second folding brace
908f first bifold point pivot structure
908s second bifold point pivot structure
909f first folding brace mounting bracket pivot structure
909s second folding brace mounting bracket pivot structure
910f first folding side-panel baffle
910s second folding side-panel baffle
1000 single hung window
1002 window frame
1004 fixed upper window pane
1006 sliding lower window pane
1006l lower edge of sliding lower window
1008 track for sliding lower window
1010 track for second slide pin (906s)
1012 window bottom lip

Having thus described the invention, it is now claimed:

I claim:

1. A rain shield for an exterior architectural window, comprising:
a shield member defining a generally rectangular-planar surface having a top edge, a bottom edge, a first side edge, and a second side edge;
a first side panel member defining a generally triangular-planar surface having an outward face and an inward face, and having three side edges, namely, a top side edge, a hinge side edge, and a clasp side edge, wherein the hinge side edge is hingedly joined to the first side edge of the shield member;
a first clasp member disposed at the clasp side edge of the first side panel member and comprising a portion of the first side panel member turned outwardly at about 90 degrees relative to the outward face of the first side panel member;
a second side panel member defining a generally triangular-planar surface having an outward face and an inward face, and having three side edges, namely, a top side edge, a hinge side edge, and a clasp side edge, wherein the hinge side edge is hingedly joined to the first side edge of the shield member; and
a second clasp member disposed at the clasp side edge of the second side panel member and comprising a portion of the second side panel member turned outwardly at about 90 degrees relative to the outward face of the second side panel member.

2. The rain shield of claim 1, wherein the shield member defines a width between the first and second side edges approximately equal to the width of a co-operable architectural window opening.

3. The rain shield of claim 1, wherein the shield member comprises:
an inner shield panel defining a generally rectangular-planar surface having a top edge, a bottom edge, a first side edge, and a second side edge; and
an outer shield panel defining a generally rectangular-planar surface having a top edge, a bottom edge, a first side edge, and a second side edge, wherein the outer shield panel further comprises a top channel disposed at the top edge of the outer shield panel, and a bottom channel disposed at the bottom edge of the outer shield panel, and wherein the top channel slideably receives the top edge of the inner shield panel, and the bottom channel slideably receives the bottom edge of the inner shield panel.

4. The rain shield of claim 3, wherein the first side panel member is hingedly joined to the first side edge of the outer shield panel, and the second side panel member is hingedly joined to the second side edge of the inner shield panel.

5. The rain shield of claim 4, wherein the hinge side edges of the first and second side panel members are hingedly joined to the shield member through first and second flex hinge panels.

6. The rain shield of claim 3 further comprising a bottom channel defined by a flap of the outer shield panel extending from the bottom edge of the outer shield panel parallel to and spaced apart from the outer shield panel.

7. The rain shield of claim 6 further comprising a top channel defined by a flap of the outer shield panel extending from the top edge of the outer shield panel parallel to and spaced apart from the outer shield panel.

8. A rain shield for an exterior architectural window, comprising:
a shield member comprising:
an inner shield panel defining a generally rectangular-planar surface having a top edge, a bottom edge, a first side edge, and a second side edge; and
an outer shield panel defining a generally rectangular-planar surface having a top edge, a bottom edge, a first side edge, and a second side edge, wherein the outer shield panel further comprises a top channel disposed at the top edge of the outer shield panel, and a bottom channel disposed at the bottom edge of the outer shield panel, and wherein the top channel slideably receives the top edge of the inner shield panel, and the bottom channel slideably receives the bottom edge of the inner shield panel;
a first side panel member defining a generally triangular-planar surface having an outward face and an inward face, and having three side edges, namely, a top side edge, a hinge side edge, and a clasp side edge, wherein the first side panel member is hingedly joined to the first side edge of the outer shield panel by a first flex hinge panel;
a first clasp member disposed at the clasp side edge of the first side panel member and comprising a portion of the first side panel member turned outwardly at about 90 degrees relative to the outward face of the first side panel member;
a second side panel member defining a generally triangular-planar surface having an outward face and an inward face, and having three side edges, namely, a top side edge, a hinge side edge, and a clasp side edge, wherein the second side panel member is hingedly joined to the second side edge of the inner shield panel by a second flex hinge panel; and
a second clasp member disposed at the clasp side edge of the second side panel member and comprising a portion of the second side panel member turned outwardly at about 90 degrees relative to the outward face of the second side panel member.

9. A rain shield for an exterior architectural window, comprising:
a shield member defining a generally rectangular-planar surface having a top edge, a bottom edge, a first side edge, and a second side edge;
a first lower fixed pivot disposed on a lower portion of the first side of the shield member;
a second lower fixed pivot disposed on a lower portion of the second side of the shield member, wherein the first and second fixed pivots are oppositely directed from each other;
a first retractable upper lateral support disposed on an upper portion of the first side of the shield member; and
a second retractable upper lateral support disposed on an upper portion of the second side of the shield member.

10. The rain shield of claim 9, wherein the shield member comprises an upper shield member and a lower shield member subtending an interior angle φ between 100° and 170°.

11. The rain shield of claim 9, wherein the first upper lateral support comprises a first folding brace having a first slide pin outward-laterally disposed on an outward-facing surface of the first folding brace.

12. The rain shield of claim 11, wherein the second upper lateral support comprises a second folding brace having a second slide pin outward-laterally disposed on an outward-facing surface of the second folding brace, wherein the first and second slide pins are co-operable with laterally disposed vertical tracks of a window frame to support the rain shield in tension with the vertical tracks.

13. The rain shield of claim 9, wherein the first lower fixed pivot, the second lower fixed pivot, the first upper lateral support, and/or the second upper lateral support are adapted to retain the rain shield in a stowed and/or deployed configuration.

14. The rain shield of claim 9, wherein the first and/or second lower fixed pivots comprise either a pivot pin or a recess operable to receive a pivot pin, the pivot pin and recess being co-operably matable as a journal bearing.

15. The rain shield of claim 9, further comprising a window frame;
wherein the first upper lateral support comprises a first folding brace having a first slide pin outward-laterally disposed on an outward-facing surface of the first folding brace;
wherein the second upper lateral support comprises a second folding brace having a second slide pin outward-laterally disposed on an outward-facing surface of the second folding brace;
a first laterally disposed vertical track of the window frame co-operable with the first slide pin to support the rain shield in tension, the first slide pin being slidably received by the first vertical track;
a second laterally disposed vertical track of the window frame co-operable with the second slide pin to support the rain shield in tension, the second slide pin being slidably received by the second vertical track; and
wherein the window frame is dimensioned to receive the shield member, the first and second lower fixed pivots, and the first and second upper lateral supports in a fully stowed configuration without interfering with the window frame or with an upper or lower window pane.

16. The rain shield of claim 9 further comprising a first folding side-panel baffle affixed to the first side of the shield member, and a second folding side-panel baffle affixed to the second side of the shield member.

17. The rain shield of claim 16 wherein the first folding side-panel baffle is affixed to the first retractable upper lateral support, and wherein the second folding side-panel baffle is affixed to the second retractable upper lateral support.
